(19) United States
(12) Patent Application Publication
(10) Pub. No.: US 2007/0121625 A1
(43) Pub. Date: May 31, 2007

(54) Method and device for creating/reproducing multimedia file, and information recording medium storing multimedia file

(75) Inventors: Cheol-kyu Youn, Suwon-si (KR); Jung-min Shin, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/583,898

(22) Filed: Oct. 20, 2006

(30) Foreign Application Priority Data
Nov. 30, 2005 (KR) 2005-115839

(51) Int. Cl. H04L 12/56; H04J 3/24

(52) U.S. Cl. 370/389; 370/474

(57) ABSTRACT

A method and device for creating/reproducing a multimedia file, and an information recording medium recording the multimedia file are provided. According to the method for creating the multimedia file, multimedia raw data is coded in accordance with characteristics of a device reproducing the multimedia raw data. After that, header information containing device identification (ID) information of the device is attached to the coded multimedia data, so that the multimedia file is created.

### CROSS-REFERENCE TO RELATED PATENT APPLICATION

This application claims all benefits accruing under 35 U.S.C. §119 from Korean Patent Application No. 2005-115839, filed on Nov. 30, 2005, in the Korean Intellectual Property Office, the disclosure of which is incorporated by reference herein.

### BACKGROUND OF THE INVENTION

1. Field of the Invention

The present invention relates to a method and device for creating/reproducing a multimedia file, and an information recording medium recording the multimedia file.

2. Related Art

Existing multimedia file formats do not provide mechanisms to support only designated products or models. Particularly, current MPEG4-based file format does not individually support a MPEG4 file that supports a product or a model of a particular company. As well known, MPEG4 (Moving Picture Experts Group) is the current worldwide standard for interactive multimedia creation, delivery, and playback for the Internet. However, it is impossible to manage recording a history and characteristics of a file. A generic multimedia file format 100, as specified as a part of MPEG4,is shown in FIG. 1, also known as the resource interchange file format (RIFF) 110 to store data 120 such as digital audio and digital streams, as defined by MPEG, as well as other data such as subtitles and still images. Since these MPEG4-based multimedia file formats, as shown in FIG. 1, do not have a separate control method or control mechanism, it is not possible for a particular company to individually control a particular product or a model.

### SUMMARY OF THE INVENTION

Several aspects and example embodiments of the present invention provide a method and device for creating/reproducing a multimedia file format and a multimedia file, which is capable of allowing the multimedia file to be reproduced only by a predetermined authenticated device or model.

Additional aspects and/or advantages of the invention will be set forth in part in the description which follows and, in part, will be obvious from the description, or may be learned by practice of the invention.

In accordance with an embodiment of the present invention, there is provided a method for creating a multimedia file, comprising: coding multimedia raw data according to the characteristics of a device reproducing the multimedia raw data; and attaching header information containing device identification information of the device to coded multimedia data to create a multimedia file.

According to an aspect of the present invention, the device ID information may represent information identifying a model of the device.

According to an aspect of the present invention, the header information may include at least one of version information of a header of the multimedia file, a multimedia file creation date, a protection mode, a compression mode, a codec bit rate, an audio bit rate, an audio sampling frequency, an audio mode, the number of colors used, a video resolution, a device name, a filename, and an extension representing a file type.

In accordance with another embodiment of the present invention, there is provided an information recording medium having a multimedia file recorded thereon, the multimedia file including: coded multimedia data and header information including device ID information, such that the multimedia file can only be reproduced, when the device ID information included in the header information matches device ID information of a device reproducing the multimedia data.

In accordance yet with another embodiment of the present invention, there is provided a method for reproducing a multimedia file, comprising: extracting header information from the multimedia file; recognizing device ID information from extracted header information; determining whether the recognized device ID information matches with device ID information of a device reproducing the multimedia file; and reproducing the multimedia file according to the determination result.

According to an aspect of the present invention, the multimedia file is reproduced using fields contained in the extracted header information, when the recognized device ID information from the extracted header information matches with the device ID information of the device reproducing the multimedia file.

According to another aspect of the present invention, the multimedia file is reproduced without reference to the extracted header information, or is not reproducible, when the recognized device ID information from the extracted header information does not match with the device ID information of the device reproducing the multimedia file.

In accordance with another embodiment of the present invention, there is provided a device for reproducing a multimedia file, comprising: a controller arranged to recognize device ID information from header information extracted from the multimedia file, and determining whether the recognized device ID information from the extracted multimedia file matches with device ID information of a device reproducing the multimedia file; and a reproduction unit arranged to reproduce the multimedia file according to the determination results.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a view illustrating a file format of a typical MPEG4 file;

FIG. 2 is a flowchart of a method for creating a multimedia file according to an embodiment of the present invention;

FIG. 3 is a view illustrating a multimedia file format according to an embodiment of the present invention;

FIG. 4 is a view illustrating a detail structure of header information shown in FIG. 3;

FIG. 5 is a view illustrating descriptions of respective items included in the header information shown in FIG. 4;

FIG. 6 is a view illustrating an example device for reproducing a multimedia file according to an embodiment of the present invention; and

FIG. 7 is a flowchart of a method for reproducing a multimedia file according to an embodiment of the present invention.

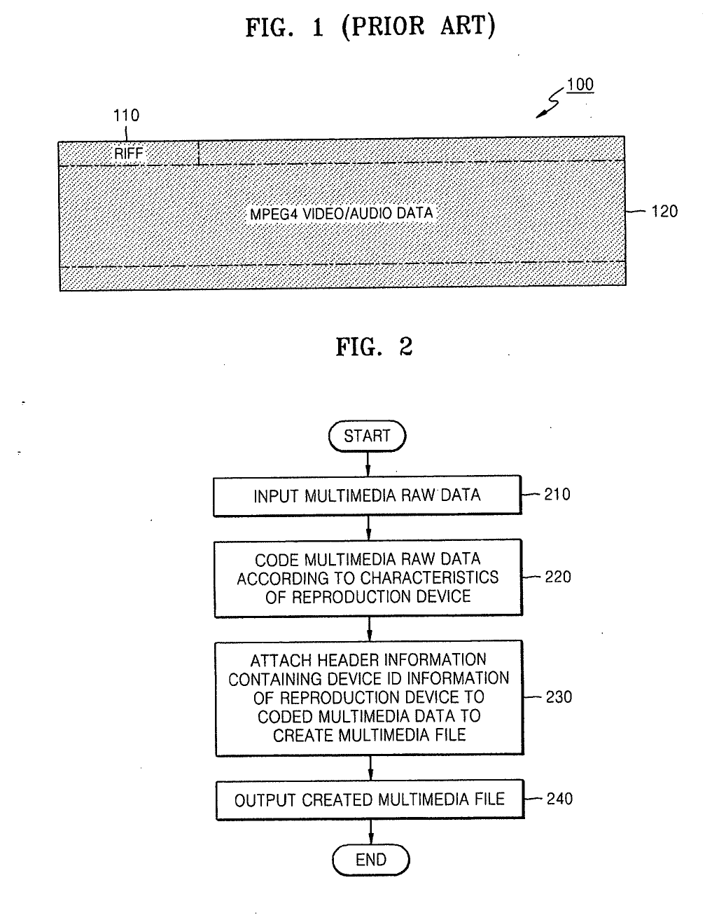

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

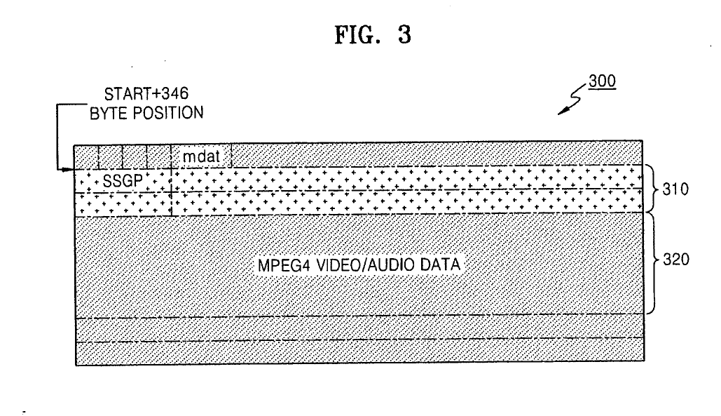

FIG. 2 is a flowchart of a method for creating a multimedia file according to an embodiment of the present invention. Referring to FIG. 2, multimedia raw data is input for creation of a multimedia file according to an embodiment of the present invention at operation 210. The multimedia raw data is then coded according to characteristics of a designated device (e.g., reproduction device) reproducing the multimedia raw data at operation 220. Header information containing device ID information of the designated device is attached to the coded multimedia data to create a multimedia file at operation 230. The created multimedia file is then output at operation 240.

Turning now to FIG. 3, an example multimedia file format according to an embodiment of the present invention is illustrated. Referring to FIG. 3, a multimedia file format 300 includes header information 310 and video/audio data 320 as specified by MPEG4.

The video/audio data 320 may be data formed by coding multimedia raw data according to the characteristics of a designated device (e.g., reproduction device) reproducing the multimedia raw data.

The header information 310 may be data providing additional information regarding multimedia data included in a multimedia file. Particularly, the header information 310 contains device ID information for a designated device (e.g., reproduction device) reproducing the multimedia data. In addition, the header information 310 may further contain additional information used for reproducing the multimedia data besides the ID information.

Referring to FIG. 3, the header information 310 is located at a position that corresponds to an initial start position+346 bytes in a multimedia file of a multimedia file format. However, the present invention is not limited to this arrangement. That is, such header information 310 may be located at any position prepared to provide additional information regarding multimedia data, while not influencing on a position on which the multimedia data is recorded according to a standard format of a multimedia file, such as a MPEG4-based file format.

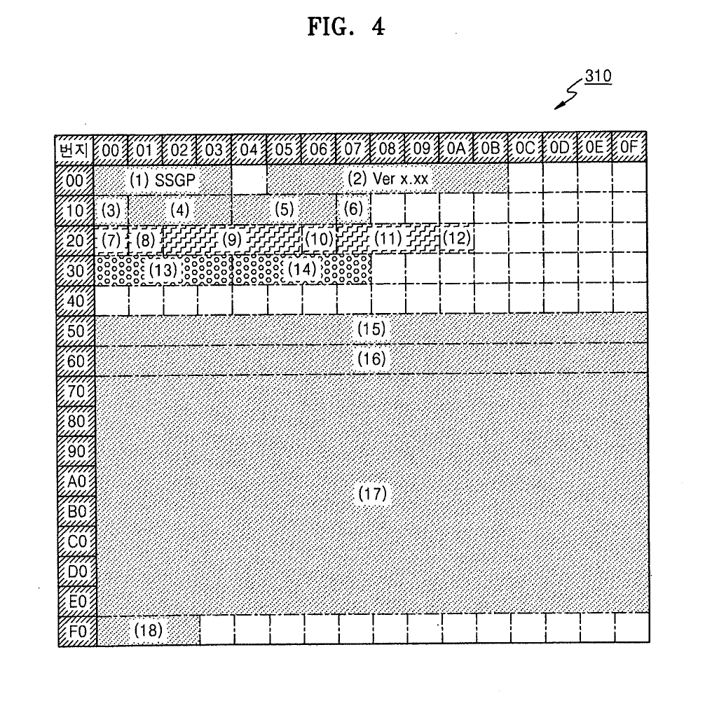

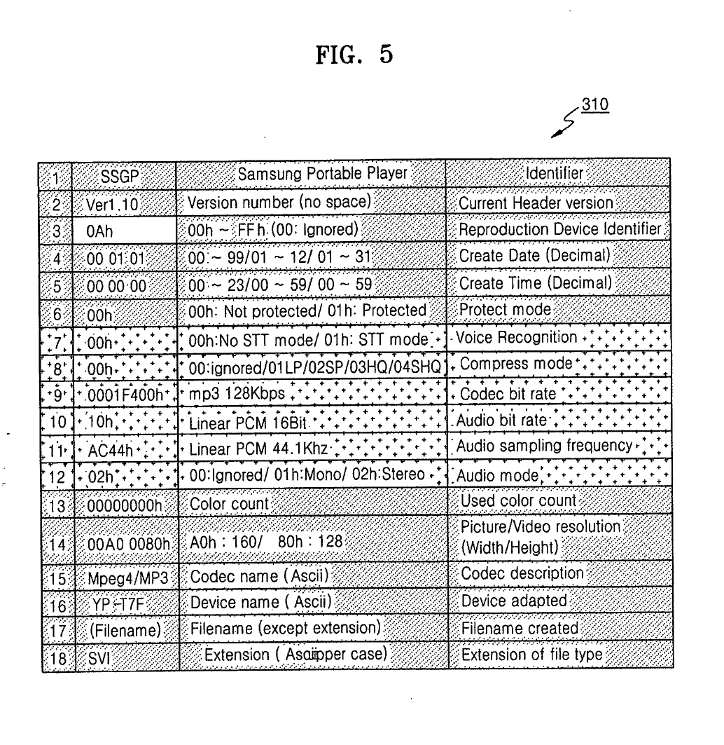

FIG. 4 illustrates an example detail structure of header information as shown in FIG. 3, and FIG. 5 provides descriptions of respective items included in the detail structure of the header information shown in FIG. 4. The respective items that may be included in the header information are described with reference to FIGS. 4 and 5 as follows.

(1) SSGP: An identifier used for recognizing a header of a multimedia file according to an embodiment of the present invention. Particularly, the SSGP may be used as an identifier for a predetermined company. For example, “SSGP” shown in FIG. 5 represents an abbreviation of Samsung portable player.

(2) Ver 1.10: Version information of a header of the multimedia file. Such a version may change when content of the header afterward is modified. The version information is used for a reproduction device to determine relevant multimedia data.

(3) Device ID Information: A unique ID assigned to a particular device or product in which such a product may be recognized for each model. A value from 00h to FFh may be used for the device ID information. For example, “0A” may be used to represent model “YP-T7F”, and “0B” may be used for representing model “YP-T9” of MP3 players manufactured by Samsung Electronics Co., Ltd. When the device ID information is recorded as additional information on the header information of a multimedia file as described in connection with FIG. 4 and FIG. 5, a device reproducing a multimedia file may recognize the device ID information afterward and effectively reproduce the multimedia file when the recognized device ID information coincides with device ID information assigned to the device itself. That is, when the device ID information contained in the multimedia file coincides with the device ID information of the device itself, the device reproducing the multimedia file reproduces the multimedia file with reference to a variety of reproduction-related information included in the header information contained in the multimedia file, so as to appropriately reproduce the multimedia file in accordance with the characteristics of the multimedia file.

(4) Creation Data: Data when a multimedia file is created.

(5) Creation Time: Time when a multimedia file is created.

(6) File Protection Status: Field used to determine whether to protect a multimedia file from deletion/copy.

(7) Voice Recognition: Field used when a multimedia file is used in a voice recognition mode afterward.

(8) Compression Mode: Field used to describe information regarding a compression level of voices.

(9) Codec Bit Rate: Field used to describe a codec bit rate of a multimedia file

(10) Audio Bit Rate: Field used to describe information regarding an audio bit rate

(11) Audio Sampling Frequency: Field used to describe the frequency of audio sampling. The audio sampling frequency is used when a reproduction device reproduces an audio.

(12) Audio Mode: Field used to describe an audio mode status of a multimedia file. A reproduction device determines an audio reproduction type with reference to this field.

(13) Used Color Count: Field used to represent the number of colors used.

(14) Picture/Video Resolution: Field used to represent horizontal and vertical resolution of a still image or a moving image.

(15) Codec Name: Field used to describe a codec name. For example, in MPEG4/MP3, an audio portion is MP3 and a video portion is MPEG4.

(16) Device Name: Field used to describe a device name (model name).

(17) File Name: Field used to describe a filename except extension.

(18) Extension: Field used to describe an extension in a file type. For example, an extension may be “SVI” for Samsung Electronics Co., Ltd.

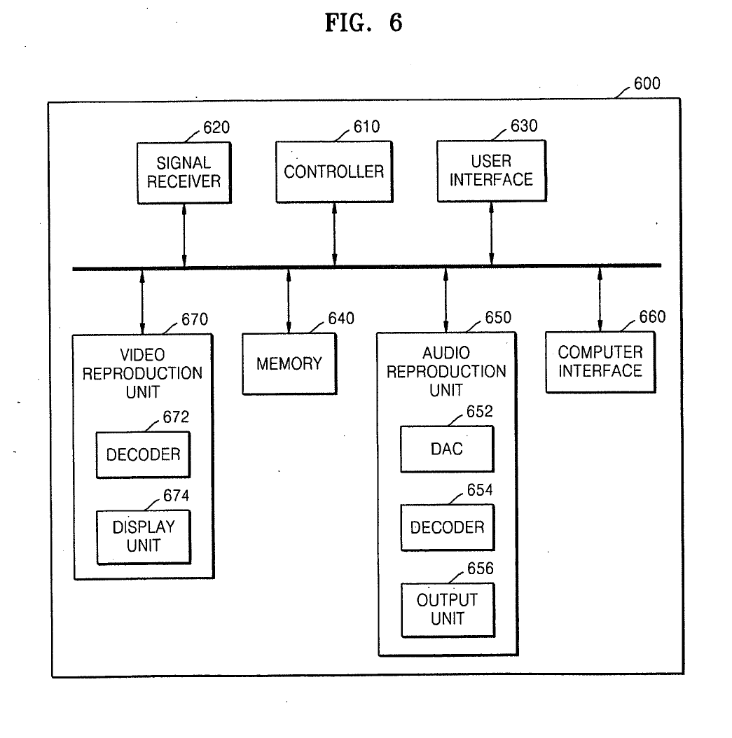

FIG. 6 is a view illustrating an example apparatus for reproducing a multimedia file according to an embodiment of the present invention.

Referring to FIG. 6, a reproduction apparatus 600 for reproducing a multimedia file comprises a controller 610, a signal receiver 620 arranged to receive an RF signal, a user interface 630 arranged to receive an operation command from a user, a memory 640 arranged to store a downloaded file, an audio reproduction unit 650 arranged to reproduce an audio file stored in the memory 640, a computer interface 660 arranged to establish connection with a host, such as a computer used to download a multimedia file such as an MP3 file, and a video reproduction unit 670 arranged to reproduce a video file stored in the memory 640.

The user interface 630 provides function buttons, such as a selection button, a reproduction button, and a stop button to receive a user's operation command.

The audio reproduction unit 650 includes a decoder 652 used to recover an MP3 music file stored in the memory 640, a digital-to-analog converter (DAC) 654 used to convert the recovered MP3 music file from digital signals to analog signals, and an output unit 656 used to output the converted analog signals to an external device, such as a headphone or other reproduction device.

The video reproduction unit 670 includes a decoder 672 used to recover a video file stored in the memory 640, and a display unit 674 used to provide a visual display of the recovered video file.

The controller 610 controls the device reproducing the multimedia file as the whole. For example, the controller 610 receives information regarding a multimedia file from the signal receiver 620 or the user interface 630, searches the multimedia file on the memory 640, and outputs the searched multimedia file to the audio reproduction unit 650 and/or the video reproduction unit 670. The controller 610 controls the audio reproduction unit 650 and/or the video reproduction unit 670 to reproduce a relevant content, and performs and processes a command input from a user, via the user interface 630.

Particularly, the controller 610 extracts header information, such as header information 310 from a multimedia file 300 as shown in FIG. 3, recognizes device ID information from the extracted header information, and determines whether the recognized device ID information coincides with device ID information of a device reproducing the multimedia file. The controller 610 may reproduce or may not reproduce the multimedia file depending on such a result. For example, when the recognized device ID information coincides with the device ID information of the device reproducing the multimedia file, the controller 610 controls the audio reproduction unit 650 and/or the video reproduction unit 670 to reproduce the multimedia file using fields contained in the header information. When the recognized device ID information does not coincide with the device ID information of the device reproducing the multimedia file, the controller 610 controls the audio reproduction unit 650 and/or the video reproduction unit 670 to reproduce the multimedia file without reference to the extracted header information, or alternatively, not to reproduce the multimedia file and provide a visual display of a message informing that the multimedia file cannot be reproduced, via the display unit 674.

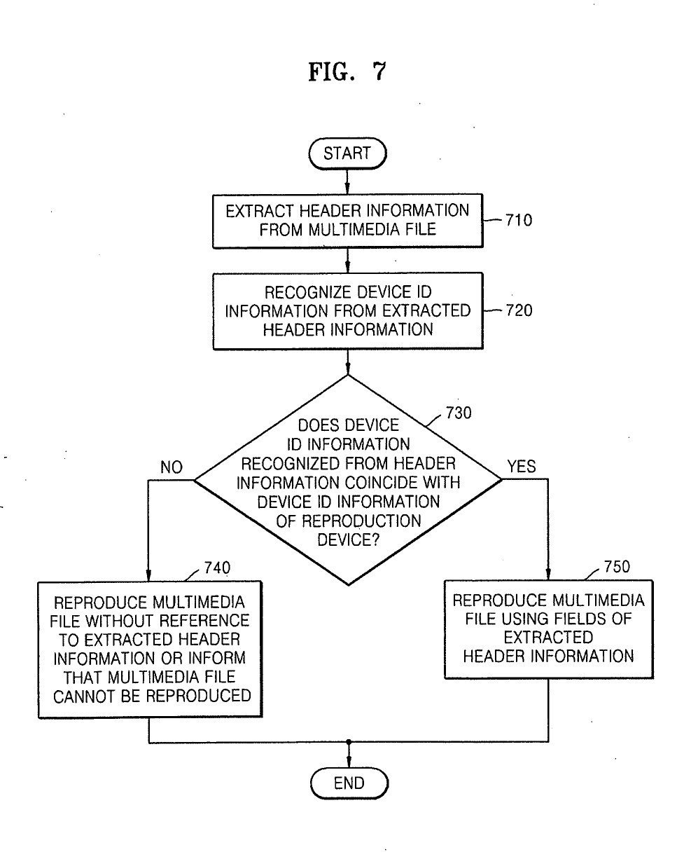

FIG. 7 is a flowchart of a method for reproducing a multimedia file according to an embodiment of the present invention.

Referring to FIG. 7, when receiving a command of reproducing a multimedia file, a controller 610 of a device reproducing a multimedia file (e.g., reproduction device 600, as shown in FIG. 6) extracts header information from the multimedia file at operation 710. Next, the controller 610 recognizes device ID information from the extracted header information at operation 720.

After that, the controller 610 determines whether the recognized device ID information coincides with device ID information of a device reproducing a multimedia file (e.g., reproduction device 600 as shown in FIG. 6) at operation 730. When the recognized device ID information coincides with the device ID information of the device reproducing the multimedia file as a result of such a determination, the controller 610 controls an audio reproduction unit 650 and/or a video reproduction unit 670 to reproduce the multimedia file using additional information contained in respective fields of the extracted header information at operation 750.

When the recognized device ID information does not coincide with the device ID information of the device reproducing the multimedia file, the controller 610 controls the audio reproduction unit 650 and/or the video reproduction unit 670 to reproduce the multimedia file without reference to the extracted header information, or outputs a message informing that the multimedia file cannot be reproduced to a user interface at operation 740.

Various components of the reproduction device, such as the signal receiver, the user interface, the audio reproduction unit, the video reproduction unit and the computer interface, as shown in FIG. 6, can be implemented in software or hardware, such as, for example, an application specific integrated circuit (ASIC) or printed circuit board (PCB). As such, it is intended that the processes described herein be broadly interpreted as being equivalently performed by software, hardware, or a combination thereof. Software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs), CD-R, CD-R/W or digital video discs (DVDs), DVD-R/W, HD-DVD, Blu-ray and other advanced optical disks (AODs). Instructions of the software routines or modules may also be loaded or transported into the testing device on a network (wire or wireless) in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

According to the present invention, a multimedia file that may be reproduced at a predetermined company and a predetermined device may be recognized, so that the reproduction of a multimedia file may be effectively performed.

While this invention has been particularly shown and described with reference to preferred embodiments thereof, it will be understood by those skilled in the art that various changes in form and details may be made therein without departing from the spirit and scope of the invention. For example, header information as shown in FIG. 3 and FIG. 4 may be located at different location in a multimedia file. In addition, different items within header information can be arranged differently as shown in FIG. 4 and FIG. 5. Moreover, a reproducing apparatus as shown in FIG. 6 can be implemented as part of a recording apparatus, or alternatively a single apparatus for performing recording and/or reproducing functions with respect to a storage medium. Similarly, the CPU can be implemented as a chipset having firmware, or alternatively, a general or special purposed computer programmed to perform the methods as described, for example, with reference to FIG. 7. Furthermore, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, both the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A method for creating a multimedia file, the method comprising:
coding multimedia raw data according to characteristics of a device reproducing the multimedia raw data; and
attaching header information containing device identification (ID) information of the device to coded multimedia data to create a multimedia file.

2. The method as claimed in claim 1, wherein the device ID information represents information identifying a model of the device.

3. The method as claimed in claim 1, wherein the header information comprises at least one of version information of a header of the multimedia file, a multimedia file creation date, a protection mode, a compression mode, a codec bit rate, an audio bit rate, an audio sampling frequency, an audio mode, the number of colors used, a video resolution, a device name, a filename, and an extension representing a file type.

4. An information recording medium having a multimedia file recorded thereon, the multimedia file comprising:
coded multimedia data; and
header information including device ID information, wherein the multimedia file is reproduced, when the device ID information included in header information matches device ID information of a device reproducing the multimedia file.

5. The information recording medium as claimed in claim 4, wherein the device ID information represents information identifying a model of the device.

6. The information recording medium as claimed in claim 4, wherein the header information comprises at least one of version information of a header of the multimedia file, a multimedia file creation date, a protection mode, a compression mode, a codec bit rate, an audio bit rate, an audio sampling frequency, an audio mode, the number of colors used, a video resolution, a device name, a filename, and an extension representing a file type.

7. The information recording medium as claimed in claim 4, wherein the header information is located on an available region of the multimedia file that does not have an influence on a standard format of the multimedia file.

8. A method for reproducing a multimedia file, the method comprising:
extracting header information from the multimedia file;
recognizing device ID information from extracted header information;
determining whether the recognized device ID information from the extracted header information matches with device ID information of a device reproducing the multimedia file; and
reproducing the multimedia file according to the determination result.

9. The method as claimed in claim 8, wherein, when the recognized device ID information from the extracted header information matches the device ID information of the device reproducing the multimedia file, the multimedia file is reproduced using fields contained in the extracted header information.

10. The method as claimed in claim 8, wherein, when the recognized device ID information from the extracted header information does not match the device ID information of the device reproducing the multimedia file, the multimedia file is reproduced without reference to the extracted header information, or a message is generated to inform a user that the multimedia file cannot be reproduced.

11. The method as claimed in claim 8, wherein the device ID information represents information identifying a model of the device.

12. The method as claimed in claim 8, wherein the header information comprises at least one of version information of a header of the multimedia file, a multimedia file creation date, a protection mode, a compression mode, a codec bit rate, an audio bit rate, an audio sampling frequency, an audio mode, the number of colors used, a video resolution, a device name, a filename, and an extension representing a file type.

13. A device for reproducing a multimedia file, the device comprising:
a controller arranged to recognize device ID information included in header information extracted from the multimedia file, and determine whether the recognized device ID information matches with device ID information of a device reproducing the multimedia file; and
a reproduction unit arranged to reproduce the multimedia file according to the determination result.

14. The device as claimed in claim 13, wherein the reproduction unit reproduces the multimedia file using fields contained in the header information, when the recognized device ID information matches with the device ID information of the device reproducing the multimedia file.

15. The device as claimed in claim 13, wherein the reproduction unit reproduces the multimedia file without reference to the extracted header information, or does not reproduce the multimedia file, when the recognized device ID information does not match with the device ID information of the device reproducing the multimedia file.

16. The device as claimed in claim 13, wherein the device ID information represents information identifying a model of the device.

17. The device as claimed in claim 13, wherein the header information comprises at least one of version information of a header of the multimedia file, a multimedia file creation date, a protection mode, a compression mode, a codec bit rate, an audio bit rate, an audio sampling frequency, an audio mode, the number of colors used, a video resolution, a device name, a filename, and an extension representing a file type.

18. The method as claimed in claim 8, wherein the multimedia file is created by coding multimedia raw data according to characteristics of the device reproducing the multimedia file, and attaching header information containing device ID information of the device to coded multimedia data.

19. The method as claimed in claim 18, wherein the device ID information represents information identifying a model of the device reproducing the multimedia file.

20. The method as claimed in claim 18, wherein the header information comprises:
version information of a header of the multimedia file;
multimedia file creation date and time information to indicate a date and a time when the multimedia file is created;
protection mode information to indicate whether the multimedia file is protected from deletion/copying;
compression mode information to indicate a compression level of audio/video data;
codec bit rate information to indicate a codec bit rate of the multimedia file;
audio bit rate information to indicate an audio bit rate of the multimedia file;
audio sampling frequency information to indicate an audio sampling frequency used for reproduction;
audio mode information to indicate an audio mode status of the multimedia file;
color information to indicate the number of colors used;
video resolution information to represent horizontal and vertical resolution of a still image or a moving image;
device name information to indicate a device name of the device reproducing the multimedia file; and
information to indicate a filename and an extension representing a file type.

21. The device as claimed in claim 13, wherein the multimedia file is created by coding multimedia raw data according to characteristics of the device reproducing the multimedia file, and attaching header information containing device ID information of the device to coded multimedia data.

22. The device as claimed in claim 21, wherein the device ID information represents information identifying a model of the device reproducing the multimedia file.

23. The device as claimed in claim 21, wherein the header information comprises:
version information of a header of the multimedia file;
multimedia file creation date and time information to indicate a date and a time when the multimedia file is created;
protection mode information to indicate whether the multimedia file is protected from deletion/copying;
compression mode information to indicate a compression level of audio/video data;
codec bit rate information to indicate a codec bit rate of the multimedia file;
audio bit rate information to indicate an audio bit rate of the multimedia file;
audio sampling frequency information to indicate an audio sampling frequency used for reproduction;
audio mode information to indicate an audio mode status of the multimedia file;
color information to indicate the number of colors used;
video resolution information to represent horizontal and vertical resolution of a still image or a moving image;
device name information to indicate a device name of the device reproducing the multimedia file; and
information to indicate a filename and an extension representing a file type.
